(19) United States
(12) Patent Application Publication
(10) Pub. No.: US 2004/0207742 A1
(43) Pub. Date: Oct. 21, 2004

(54) Charge-coupled device sensing apparatus

(76) Inventor: Yung-Chuan Wu, Pingjhen City (TW)

Correspondence Address: RABIN & BERDO, P.C., Suite 500, 1101 14th Street, N.W., Washington, DC, 20005, US

(21) Appl. No.: 10/645,860

(22) Filed: Aug. 22, 2003

(30) Foreign Application Priority Data
Aug. 22, 2002 (TW) 91118947

(51) Int. Cl. H04N 5/335

(52) U.S. Cl. 348/311

(57) ABSTRACT

A charge-coupled device (CCD) sensing apparatus is provided. The CCD sensing apparatus includes a first photo sensor set and a first CCD shift register. The first photo sensor set includes a number of first photo-sensors for receiving light signals and generating multiple corresponding first charge signals. The first CCD shift register includes a first CCD component set and a second CCD component set. The first CCD component set can receive part of the first charge signals and output them to a first charge storage component, while the second CCD component set can receive part of the remaining first charge signals and output them to a second charge storage component.

This application claims the benefit of Taiwan application Serial No. 91118947, filed Aug. 22, 2002.

### BACKGROUND OF THE INVENTION

1. Field of the Invention

The invention relates in general to charge-coupled device (CCD) sensing apparatus, and more particularly to a CCD sensing apparatus that can speed up the scanning procedure.

2. Description of the Related Art

In a typical scanner, a CCD sensing apparatus is applied for processing optical-signal to electrical-signal conversion. FIG. 1 shows a conventional CCD sensing apparatus 102. CCD sensing apparatus 102 includes a photo sensor set 106 with photo sensors and a CCD shift register 110. The photo sensors can be photo diodes. When the photo sensors are exposed to light for a predetermined period of time, charge signals are generated by the photo sensors and then shifted out to the CCD shift register 110. The CCD shift register 110 can be a two-phase CCD shift register. A control circuit 104 is used to sequentially store the charge signals, which are output from the CCD shift register 110, to a capacitor C to acquire the analog output signal. The output signal is processed by a next stage circuit (not shown) and the scanned image data are then obtained.

FIG. 2 is a structure diagram of a conventional CCD shift register. A CCD shift register 110 includes a number of CCD components including A1, A1′, A2, and A2′. The CCD components A1 and A2 are controlled by a control signal PHY1, and the CCD components A1′ and A2′ are controlled by a control signal PHY2. The waveform of control signals PHY1 and PHY2 are shown in FIG. 3. The CCD shift register 110 includes a metal layer 202, a silicon dioxide layer 204, and a P-type silicon layer 206. The silicon dioxide layer 204 is above the P-type silicon layer 206, and is also covered by the metal layer 202. Every CCD component has a first portion and a second portion. The silicon dioxide layer 204 in the first portion of every CCD component is thicker than that in the second portion of every CCD component. The metal layer 202 in every CCD components is not connected. By converting the control signals PHY1 and PHY2 to a high voltage level alternately to change the energy barrier of the CCD components, charge signals stored in the CCD components can be sequentially shifted out.

The operation method of shifting out the charge signals sequentially makes the operation speed of the CCD components inherently slow. The shifting out speed of the CCD shift register becomes a bottleneck when scanning a large size document or at a high resolution. Moreover, the limitation of CCD component operating speed results in difficulty when scanning a larger size document, or at a high resolution.

The following are solutions now available on the market to solve the above mentioned problem:

First, a stagger-type CCD sensing apparatus is provided. FIG. 4 shows a conventional stagger-type CCD sensing apparatus. The main components of a CCD sensing apparatus 402 are photo sensor sets 406A and 406B, and CCD shift registers 410A and 410B. The photo sensor sets 406A and 406B are arranged in a staggered configuration. CCD shift registers 410A and 410B are for receiving charge signals transmitted from the photo sensor sets 406A and 406B respectively. While the stagger-type CCD sensing apparatus 402 is used in a high-resolution scanner, even though the size of the stagger-type CCD sensing apparatus 402 is smaller than that of the CCD sensing apparatus 102, the speed to shift out the charge signals is still insufficient.

Second, an even-odd type CCD sensing apparatus is provided. FIG. 5 shows a conventional even-odd type CCD sensing apparatus. The even-odd type CCD sensing apparatus 502 includes a photo sensor set 506 and CCD shift registers 510A and 510B. The CCD shift registers 510A and 510B are located on opposite sides of the photo sensor set 506 for receiving charge signals transmitted from the photo sensor set 506. The speed of shifting out the charge signals when using the odd-even type CCD sensing apparatus is much faster than that when using the CCD sensing apparatus in FIG. 1. However, the size of the CCD sensing apparatus cannot be reduced.

Third, the way of using more than two carriages is provided. Scanning a larger size document can be achieved by using more than two carriages to scan different parts of the document. However, it is difficult to control optical inaccuracy, especially when using a scanner with an automatic document feeder. This method cannot solve the problem of low operating speed when scanning a small sized document at a high resolution.

### SUMMARY OF THE INVENTION

It is therefore an object of the invention to provide a charge-coupled device (CCD) sensing apparatus, which can speed up shifting out of charge signals from the CCD shift registers so as to speed up the scanning process while maintaining high quality image scanning.

The invention achieves one of the above-identified objects by providing a charge-coupled device (CCD) sensing apparatus including at least a first photo sensor set and a first CCD shift register. The first photo sensor set includes a number of first photo-sensors for receiving light signals and generating multiple corresponding first charge signals. The first CCD shift register includes a first CCD component set and a second CCD component set. The first CCD component set is for receiving part of the first charge signals and outputting them to a first charge storage component, while the second CCD component set is for receiving part of the remaining first charge signals and outputting them to a second charge storage component.

Accordingly, the invention achieves the other above-identified objects by providing a charge-coupled device (CCD) sensing apparatus; including at least a first photo sensor set and a first CCD shift register. The first photo sensor set includes a number of first photo-sensors for receiving light signals and generating a number of corresponding first charge signals. The first CCD shift register includes P CCD component sets, where P is a positive integer greater than 2. The P CCD component sets are coupled to a first charge storage component, respectively. The P the CCD component sets are for receiving part of the first charge signals and outputting them to the corresponding first charge storage component.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) shows a conventional CCD sensing apparatus;

FIG. 2 (prior art) shows a structural diagram of a conventional CCD shift register;

FIG. 3 (prior art) shows the waveform of control signals PHY1 and PHY2;

FIG. 4 (prior art) shows a conventional stagger-type CCD sensing apparatus;

FIG. 5 (prior art) shows a conventional even-odd type CCD sensing apparatus;

FIG. 6 illustrates a block diagram of a CCD sensing apparatus according a first embodiment of the invention;

FIG. 7 illustrates a detailed block diagram of the CCD sensing apparatus in FIG. 6;

FIG. 8 illustrates a structural diagram of the CCD shift register in FIG. 6;

FIG. 9 illustrates a block diagram of a CCD sensing apparatus according a second embodiment of the invention;

FIG. 10 illustrates a detailed block diagram of the CCD sensing apparatus 902 in FIG. 9;

FIG. 11 illustrates a block diagram of a CCD sensing apparatus according a third embodiment of the invention; and

FIG. 12 illustrates a block diagram of a CCD sensing apparatus according a fourth embodiment of the invention.

### DETAILED DESCRIPTION OF THE INVENTION

In the charge-coupled device (CCD) sensing apparatus according to the invention, a CCD shift register is sectioned into more than two CCD component sets, with each CCD component set coupled to a charge storage component through a control circuit. The charge storage component can be a capacitor. The number of CCD components in each CCD component set of CCD shift register is greatly reduced after sectioning the CCD shift register into several CCD component sets. Therefore, the time required to shift out the charge signals from each CCD component sets is reduced, so as to achieve the object of speeding up the scanning procedure.

Embodiment 1

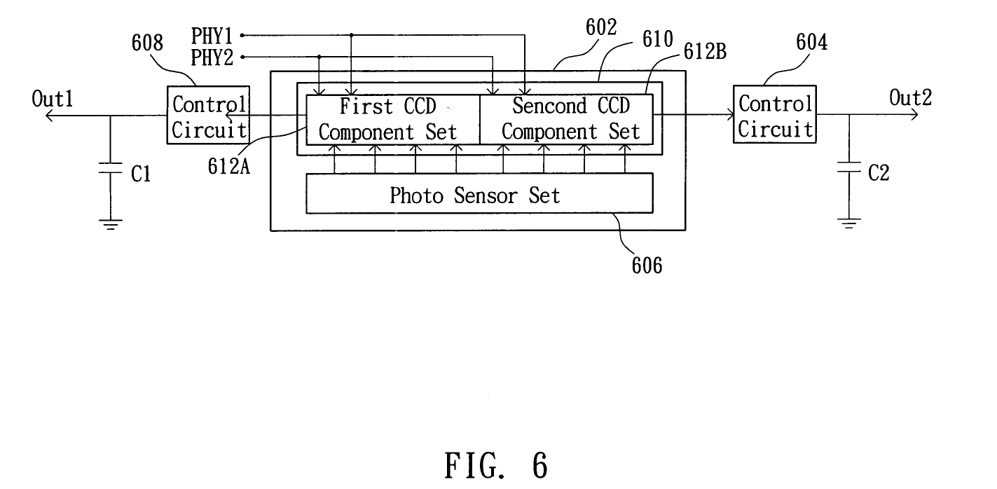

FIG. 6 shows a block diagram of a CCD sensing apparatus according a first embodiment of the invention. The CCD sensing apparatus 602 according the first embodiment of the invention includes at least a photo sensor set 606 and a CCD shift register 610. The photo sensor set 606 includes a number of photo sensors (not shown in FIG. 6) for receiving light signals and generating multiple corresponding charge signals. The CCD shift register 610 includes a first CCD component set 612A and a second CCD component set 612B, with each having a number of CCD components. The first CCD component set 612A is for receiving part of the charge signals and outputting them to a charge storage component, such as a capacitor C1, through a control circuit 608, while the second CCD component set 612B is for receiving part of the remaining charge signals and outputting the charge signals to the other charge storage component, such as a capacitor C2, through a control circuit 604.

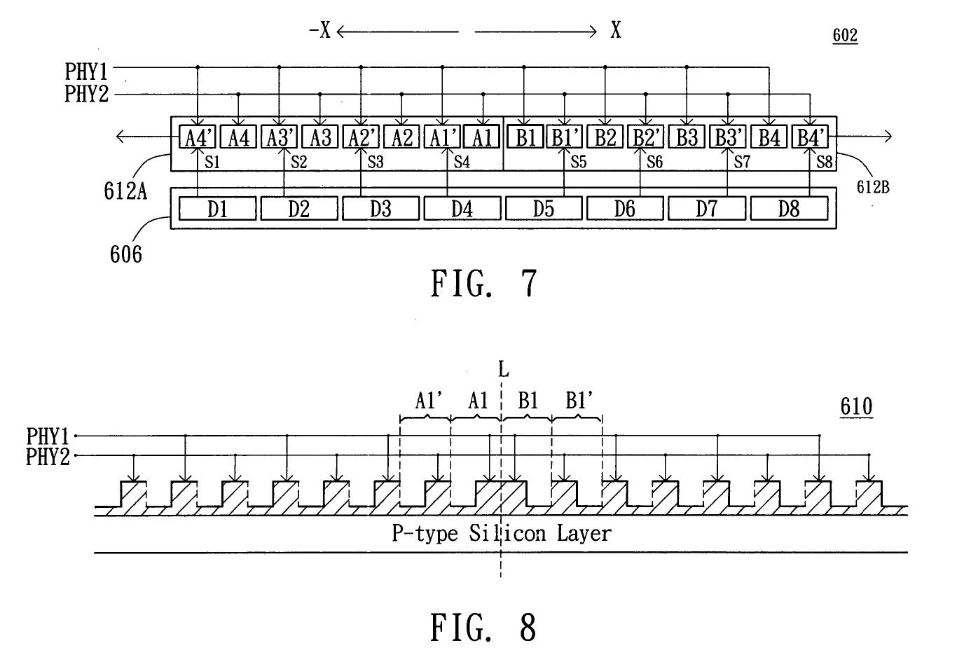

FIG. 7 is a detailed block diagram of the CCD sensing apparatus 602 shown in FIG. 6. Suppose the CCD sensing apparatus 602 is applied for scanning at a resolution of 1200 dpi (dots per inch). If the CCD sensing apparatus 602 is used for sensing a document of 16 inches in width (that is A3 size), then the photo sensor set 606 includes 1200×16=19200 photo sensors, and the two-phase CCD shift register 610 includes 19200×2=38400 CCD components. To make the explanation simple, FIG. 7 shows only 8 photo sensors D1˜D8, and 16 CCD components A1˜A4, A1′˜A4′, B1˜B4, and B1′˜B4′. The first CCD component set 612A includes the CCD components A1˜A4 and A1′˜A4′, and the second CCD component set 612B includes the CCD components B1˜B4 and B1′˜B4′.

The first CCD component set 612A and the second CCD component set 612B are controlled by the same group of control signals PHY1 and PHY2. The charge signals S4˜S1 stored in the CCD components A1′˜A4′ are sequentially shifted out along a direction of −X under the control of the control signals PHY1 and PHY2. Charge signals S5˜S8 that are stored in the CCD components B1′˜B4′ are sequentially shifted out along a direction of X under the control signals PHY1 and PHY2.

FIG. 8 is a structural diagram of the CCD shift register shown in FIG. 6. Referring to FIG. 7 and FIG. 8, the structure of the first CCD component set 612A and the second CCD component set 612B is symmetrical with respect to line L in the first embodiment of the invention. Every CCD component has a first portion with thick silicon dioxide layer and a second portion with thin silicon dioxide layer. The first portion of CCD components A1 and B1, which are next to each other, are connected. The arrangement of the first and second portions of the CCD components of the first CCD component set 612A and that of the second CCD component set 612B are symmetrical with respect to line L. Therefore, the structure enables the charge signals stored in the first CCD component set 612A and the second CCD component set 612B be shifted out in the directions of −X and X respectively as the voltage levels of control signals PHY1 and PHY2 change. That is, the charge signals are shifted out and away in two directions.

Moreover, in order to enhance the electrical isolation between the first CCD component set 612A and the second CCD component set 612B, so that the charge signals of the first CCD component set 612A and the second CCD component set 612B do not interfere with each other, the thickness of the silicon dioxide layer in the first portion of the CCD components A1 and B1 can be further thickened to enhance the energy barrier. The manner of electrical isolating in this embodiment is only one possible example. Other way for electrical isolating can also be applied between the first CCD component set 612A and the second CCD component set 612B in the embodiment.

Embodiment 2

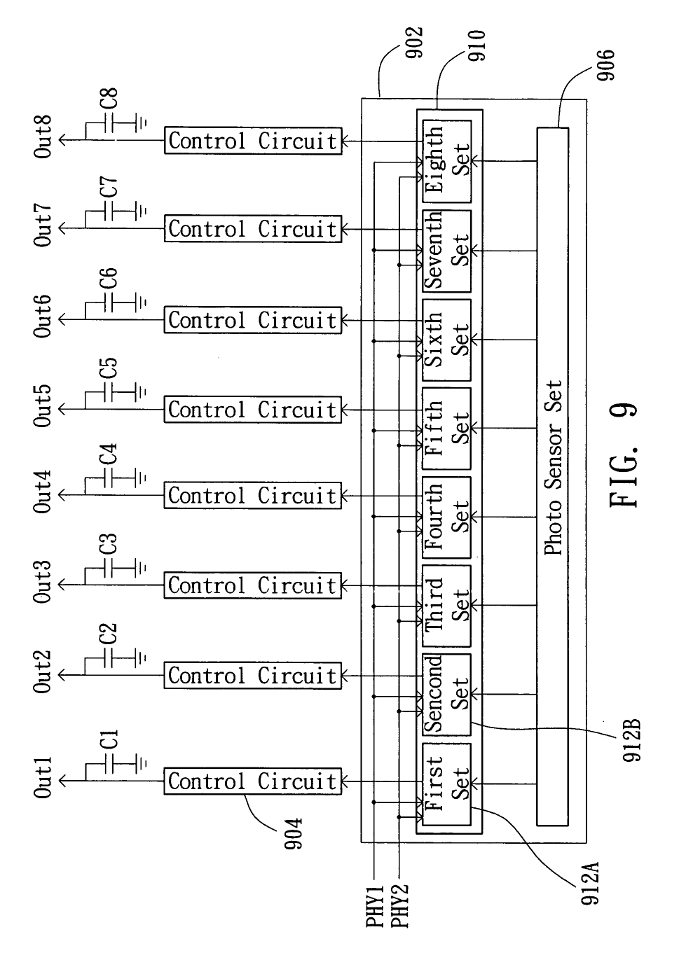

FIG. 9 shows a block diagram of a CCD sensing apparatus according a second embodiment of the invention. The CCD sensing apparatus 902 according the second embodiment of the invention includes at least a photo sensor set 906 and a CCD shift register 910. The photo sensor set 906 includes a number of photo sensors for receiving light signals and generating a number of corresponding charge signals. The CCD shift register 910 includes several CCD component sets. Each of these component sets is coupled to a charge storage component such as a capacitor, and can also receive part of the charge signals and output them to the corresponding capacitor. FIG. 9 shows eight CCD component sets in the CCD shift register 910. The eight CCD component sets are controlled by the same group of control signals PHY1 and PHY2 to shift out the charge signals to the capacitors C1˜C8 through the respective control circuits 904.

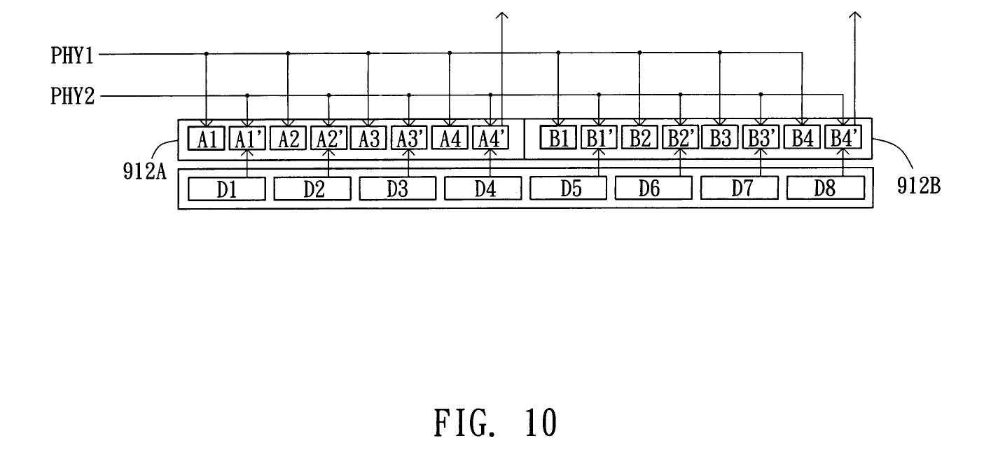

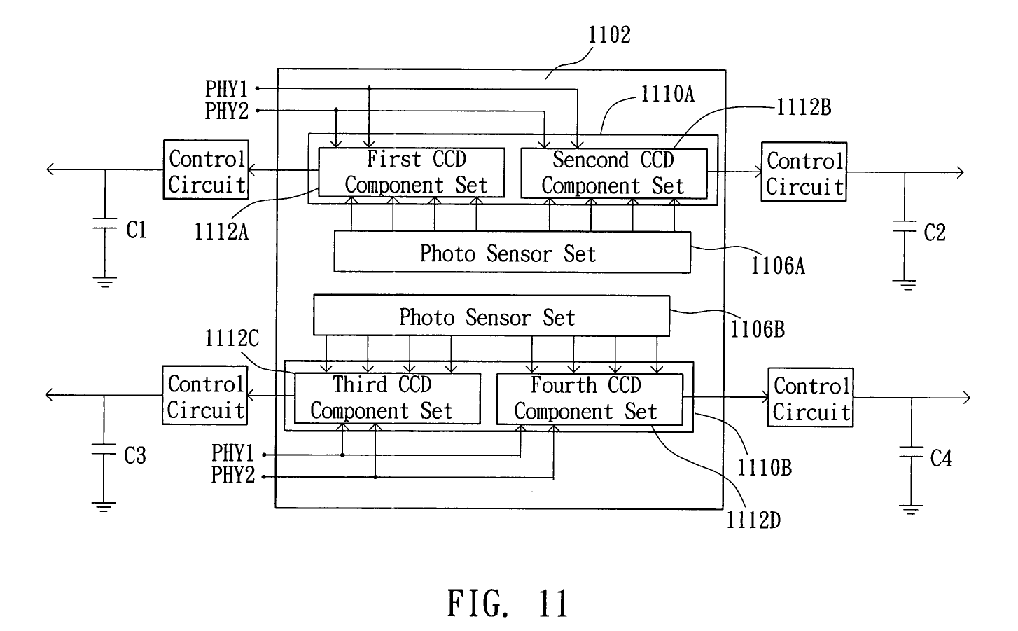

FIG. 10 shows a detailed block diagram of the CCD sensing apparatus 902 shown in FIG. 9. Here the first CCD component set 912A and the second CCD component set 912B are taken as examples. The first CCD component set 912A includes CCD components A1˜A4 and A1′˜A4′, and the second CCD component set 912B includes CCD components B1˜B4 and B1′˜B4′. The direction for shifting out the charge signals from each CCD component set can be the same so that the structure of each CCD component set can be the same as well. In addition, electrical isolation between each CCD component sets can be achieved in many ways. Electrical isolation between each CCD component set can be achieved by thickening the silicon dioxide layer of first portion of the first CCD component in each CCD component set, such as the CCD components A1 and B1, or, by applying a higher negative voltage which is disconnected from PHY1 or PHY2 to enhance the electric energy barrier. The electrical isolation between each CCD component sets can also be achieved by altering the control circuit design to have the charge signals directly shift out to the control circuits from the last CCD component of each CCD component set, such as the CCD components A4′ and B4′, instead of shifting to the first CCD component of the next CCD component set.

The technique of sectioning the CCD shift register in this invention can also be combined with the conventional stagger-type CCD sensing apparatus and the odd-even type CCD sensing apparatus to obtain a third embodiment and a fourth embodiment of the invention. The detailed descriptions are stated as follows respectively.

Embodiment 3

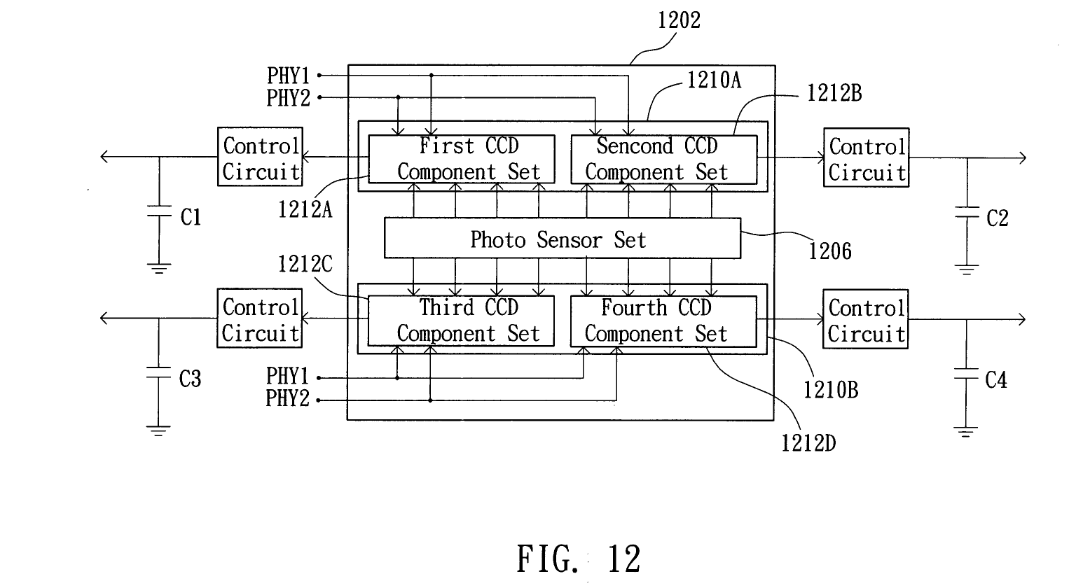

FIG. 11 is a block diagram of a CCD sensing apparatus according a third embodiment of the invention is shown. The CCD sensing apparatus 1102 according to the third embodiment of the invention includes at least photo sensor sets 1106A and 1106B and CCD shift registers 1110A and 1110B. The photo sensor set 1106A includes a number of first photo-sensors for receiving light signals and generating a number of corresponding first charge signals. Photo sensor set 1106B includes a number of second photo-sensors for receiving light signals and generating a number of corresponding second charge signals. The photo sensor sets 1106B and 1106A are arranged in a staggered configuration. The CCD shift register 1110A includes a first CCD component set 1112A and a second CCD components set 1112B. The first CCD component set 1112A is for receiving part of the first charge signals and outputting them to capacitor C1, and the second CCD component set 1112B is for receiving part of the remaining first charge signals and outputting them to capacitor C2. The CCD shift register 1110B also includes a third CCD component set 1112C and a fourth CCD component set 1112D. The third CCD component set 1112C is for receiving part of the second charge signals and outputting them to capacitor C3, and the fourth CCD component set 1112D is for receiving part of the remaining second charge signals and outputting them to capacitor C4.

CCD shift registers 1110A and 1110B can also be implemented by several CCD component sets. Suppose that the CCD shift register 1110A includes P CCD component sets, where P is a positive integer greater than 2. Each of the P CCD component sets is coupled to a capacitor. Each of the P CCD component sets can receive part of the first charge signals and output them to the corresponding capacitor. Additionally, the CCD shift register 1110B includes Q CCD component sets, where Q is a positive integer greater than 2. Each of the Q CCD component sets is coupled to a capacitor. Each of the Q CCD component sets can receive part of the second charge signals and output them to the corresponding capacitor.

Embodiment 4

FIG. 12 is a block diagram of a CCD sensing apparatus according a fourth embodiment of the invention. The CCD sensing apparatus 1202 according to the fourth embodiment of the invention includes at least a photo sensor set 1206 and shift registers 1210A and 1210B. The photo sensor set 1206 includes a number of first photo-sensors that can receive light signals and generate multiple corresponding charge signals. The CCD shift register 1210A includes a first CCD component set 1212A and a second CCD component set 1212B. The first CCD components set 1212A can receive part of the charge signals and output them to a capacitor C1, and the second CCD component set 1212B can receive the part of the remaining charge signals and output them to a capacitor C2. The CCD shift register 1210B and the CCD shift register 1210A are located on opposite sides of the photo sensor set 1206. The CCD shift register 1210B also includes a third CCD component set 1212C and a fourth CCD components set 1212D. The third CCD component set 1212C can receive part of the remaining charge signals and output them to a capacitor C3, and the fourth CCD component set 1212D can receive part of the remaining charge signals and output them to a capacitor C4.

Additionally, the CCD shift register 1210A and 1210B can also be implemented by several CCD component sets. Suppose that the CCD shift register 1210A includes P CCD component sets, where P is a positive integer greater than 2. Each of the P the CCD component sets is coupled to a capacitor. Each of the P the CCD component sets can receive part of the charge signals and output them to the corresponding capacitor. In addition, the CCD shift register 1210B may include Q CCD component sets, where Q is a positive integer greater than 2. Each of the Q CCD component sets is coupled to a capacitor. Each of the Q CCD component sets can receive part of the remaining charge signals and output them to the corresponding capacitor.

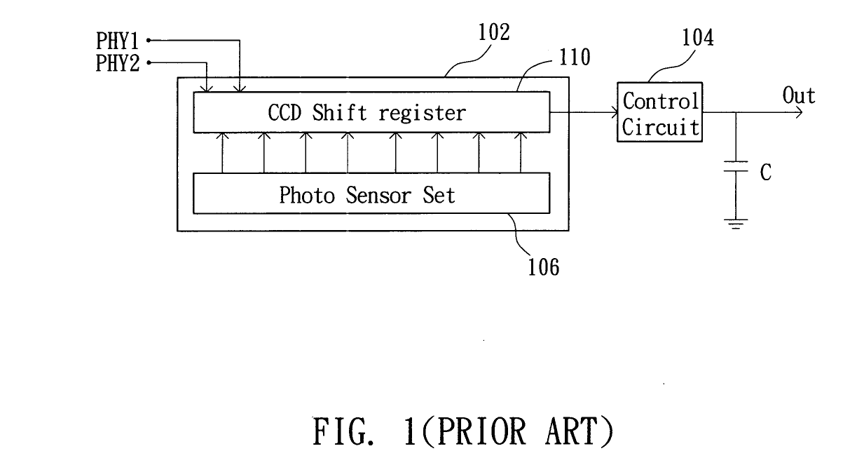

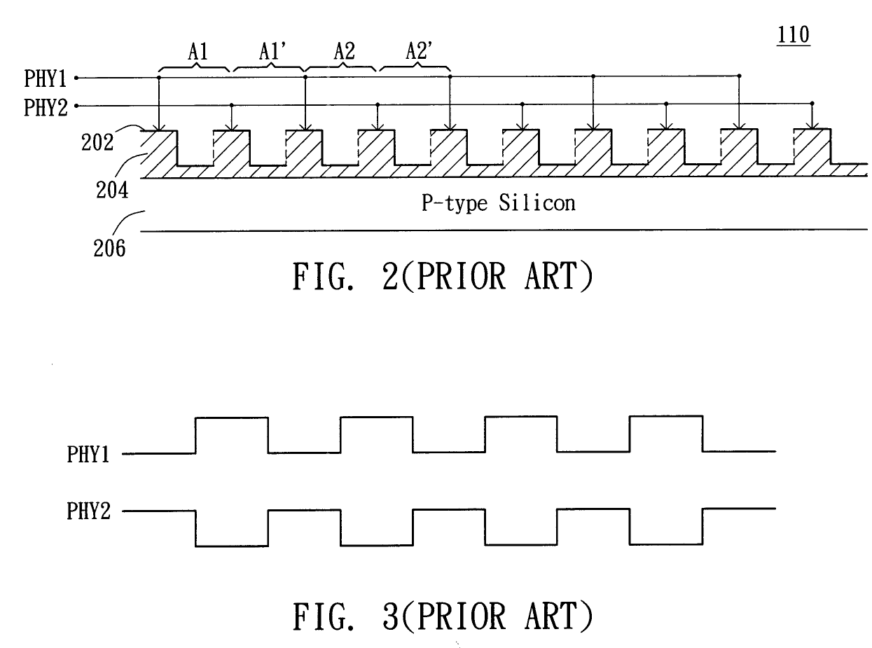

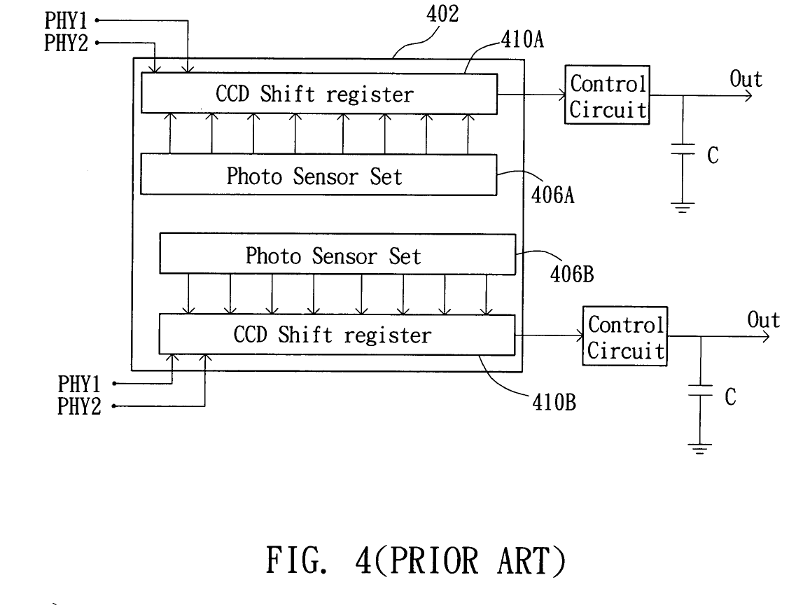

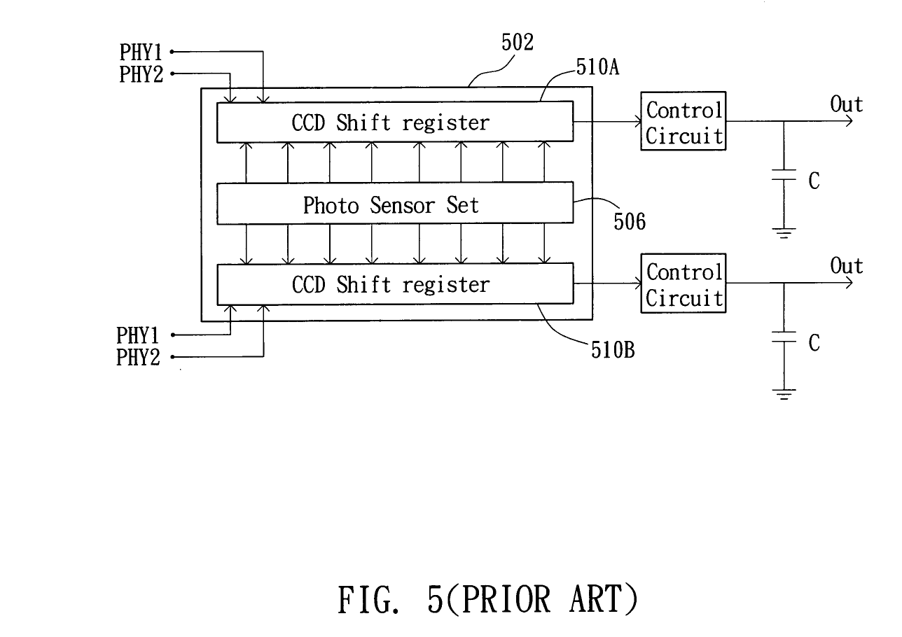

The advantage of the invention lies in being able to save time shifting out the charge signals by sectioning the CCD shift register into several CCD component sets, greatly reducing the number of CCD components that the charge signals have to go through while being shifted; thus, the invention speeds up the scanning procedure. Furthermore, since the invention only changes the structure of the CCD shift register without having an actual cut line between each CCD component set, the structure of the photo sensor set does not need to be changed according to the invention. Therefore, the carriage optical characteristics of the carriage also do not need to be changed, and the same resolution and high image quality can be achieved. The CCD shift register does not have an actual cut line, therefore the CCD sensing module does not increase in size. Moreover, the object of the invention can be achieved by applying the control signals with the waveform now widely available. It is not necessary to design new control signals with new waveform. In addition, the shifting out speed of the charge signals is related to the number of CCD component sets of the CCD shift register. The greater number of the CCD component sets that the shift register has, the faster the charge signals can be shifted out. For example, the second embodiment of the invention has a CCD shift register that is sectioned into eight CCD component sets, making it eight times faster than the original shifting speed of the charge signals in the conventional CCD shift register shown in FIG. 1.

If the invention is used for scanning at multiple-resolutions, the speed can also be increased for this application. Take the first embodiment of the invention, for scanning at a resolution of 1200 dpi, as an example; if scanning at a resolution of 600 dpi, it only needs to shift out every two charge signals and to combine the two charge signals together to obtain the voltage value, achieving scanning procedure at a resolution of 600 dpi. If scanning at a resolution of 400 dpi, it only needs to shift out every three charge signals and to combine the three charge signals together to obtain the voltage value, achieving scanning process at a resolution of 400 dpi. Because the first embodiment of the invention can double the shifting out speed of the charge signals while scanning resolutions of 600 dpi or 400 dpi, the speed of shifting out the charge signals is also doubled. Similarly, while using the second embodiment of the invention to section the CCD shift register into eight CCD component sets for scanning at multiple-resolutions, the speed of shifting the charge signals out becomes eight times greater than the original CCD shift register.

Furthermore, an advantage of the third and fourth embodiments of the invention is that by combining the invention and prior art together, the invention has the essence of both. The third embodiment of the invention can achieve not only the advantage of reducing the size of the CCD sensing apparatus but also the advantage of speeding up the shifting of the charge signals. And the fourth embodiment of the invention can increase the shifting speed of the charge signals even more.

The photo sensors of each photo sensor set in embodiments 1 to 4 can be of the same size, and also can be spaced at the same intervals. Each CCD component set can include the same number of CCD components.

The CCD sensing apparatus according to the above-mentioned embodiments of the invention can speed up the scanning procedure by speeding up the shifting of the charge signals in the CCD shift register. Additionally, it does not change the optical feature, and it also maintains high image quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A charge-coupled device (CCD) sensing apparatus, comprising:
a first photo sensor set with a plurality of first photo sensors for receiving a light signal and generating a plurality of corresponding first charge signals; and
a first CCD shift register including a first CCD component set and a second CCD component set, wherein the first CCD component set can receive a first part of the first charge signals; the first part of the first charge signals are then sequentially output from the first CCD component set to a first charge storage component and then converted to corresponding voltages; the second CCD component set can receive the remaining part of the first charge signals; and the remaining part of the first charge signals are then sequentially output from the second CCD component set to a second charge storage component and then converted to corresponding voltages.

2. The CCD sensing apparatus according to claim 1, wherein the first photo sensors are of the same size, and also are spaced at the same intervals.

3. The CCD sensing apparatus according to claim 1, wherein the first CCD component set and the second CCD component set are electrically isolated.

4. The CCD sensing apparatus according to claim 1, wherein the first CCD component set includes the same number of CCD components as the second CCD component set.

5. The CCD sensing apparatus according to claim 1, further comprising:
a second photo sensor set with a plurality of second photo sensors for receiving a light signal and generating a plurality of corresponding second charge signals, wherein the second photo sensor set and the first photo sensor set are arranged in a staggered-type configuration; and
a second CCD shift register including a third CCD component set and a fourth CCD component set, wherein the third CCD component set can receive a part of the second charge signals; the second charge signals are then sequentially output from the third CCD component set to a third charge storage component and then converted to corresponding voltages; the fourth CCD component set can receive the remaining part of the second charge signals; and the remaining part of the second charge signals are then sequentially output from the fourth CCD components set to a fourth charge storage component and then converted to corresponding voltages.

6. The CCD sensing apparatus according to claim 5, wherein the second photo sensors are of the same size as the first photo sensors, and also are spaced at the same interval as the first photo sensors.

7. The CCD sensing apparatus according to claim 1, wherein the CCD sensing apparatus is used in a scanner.

8. A charge-coupled device (CCD) sensing apparatus, comprising:
a first photo sensor set with a plurality of first photo sensors for receiving a light signal and generating a plurality of corresponding first charge signals; and
a first CCD shift register including a first CCD component set and a second CCD component set, wherein the first CCD component set can receive a first part of the first charge signals; the first part of the first charge signals are then sequentially output from the first CCD component set to a first charge storage component and then converted to corresponding voltages; the second CCD component set can receive a second part of the first charge signals; and the second part of the first charge signals are then sequentially output from the second CCD component set to a second charge storage component and then converted to corresponding voltages.
a second CCD shift register, wherein the first CCD shift register and the second CCD shift register are located on opposite sides of the first photo sensor set; the second CCD shift register includes a third CCD component set and a fourth CCD component set; the third CCD component set can receive a third part of the first charge signals; the third part of the first charge signals are then sequentially output from the third CCD component set to a third charge storage component and then converted to corresponding voltages; the fourth CCD component set can receive the remaining part of the first charge signals; and the remaining part of the first charge signals are then sequentially output from the fourth CCD component set to a fourth charge storage component and then converted to corresponding voltages.

9. A charge-coupled device (CCD) sensing apparatus, comprising:
a first photo sensor set having a plurality of first photo sensors for receiving a light signal and generating a plurality of corresponding first charge signals; and
a first CCD shift register comprising P CCD component sets, where P is a positive integer greater than 2, wherein each of the P CCD component sets is coupled to corresponding first charge storage components; each of the P CCD component sets can receive part of the first charge signals, the charge signals are then sequentially output from each of the P CCD component sets to the corresponding first charge storage components and then converted to corresponding voltages.

10. The CCD sensing apparatus, according to claim 9, wherein the first photo sensors are of the same size, and also are spaced at the same interval.

11. The CCD sensing apparatus according to claim 9, wherein the P CCD component sets are electrically isolated from each other.

12. The CCD sensing apparatus according to claim 9, wherein each of the P CCD component sets includes the same number of CCD components.

13. The CCD sensing apparatus according to claim 9, further comprising:
a second photo sensor set having a plurality of second photo sensors for receiving a light signal and generating a plurality of corresponding second charge signals, wherein the second photo sensor set and the first photo sensor set are arranged in a staggered-type configuration; and
a second CCD shift register including Q CCD component sets, where Q is a positive integer greater than 2, wherein each of the Q CCD component sets is coupled to a second charge storage component; each of the Q CCD component sets can receive part of the second charge signals; and the charge signals are then sequentially output from each of the Q CCD component sets to the corresponding second charge storage component and then converted to corresponding voltages.

14. The CCD sensing apparatus according to claim 13, wherein the second photo sensors are of the same size as the first photo sensors, and are also spaced at the same interval as the first photo sensors.

15. The CCD sensing apparatus according to claim 9, wherein the CCD sensing apparatus is used in a scanner.

16. A charge-coupled device (CCD) sensing apparatus, comprising:
a first photo sensor set having a plurality of first photo sensors for receiving a light signal and generating a plurality of corresponding first charge signals; and
a first CCD shift register comprising P CCD component sets, where P is a positive integer greater than 2, wherein each of the P CCD component sets is coupled to corresponding first charge storage components;
a second CCD shift register, wherein the first CCD shift register and the second CCD shift register are located on opposite sides of the first photo sensor set; the second CCD shift register comprises Q CCD component sets, where Q is a positive integer greater than 2; each of the Q CCD component sets is coupled to second charge storage components;
each of the P CCD component sets and Q CCD component sets can receive part of the first charge signals; and the charge signals are then sequentially output from each of the P CCD component sets and Q CCD component sets to the corresponding first charge storage components and the corresponding second charge storage components and then converted to corresponding voltages accordingly.
